(19) United States
(12) Patent Application Publication
(10) Pub. No.: US 2025/0060009 A1
(43) Pub. Date: Feb. 20, 2025

(54) CONSTANT VELOCITY JOINT

(71) Applicant: Steering Solutions IP Holding Corporation, Saginaw, MI (US)

(72) Inventors: Jeffrey P. COURVILLE, Frankenmuth, MI (US); Eduardo R. MONDRAGON-PARRA, Freeland, MI (US); Jon N. MILLER, Merrill, MI (US); Brian J. KLEINFELD, Saginaw, MI (US)

(21) Appl. No.: 18/807,397

(22) Filed: Aug. 16, 2024

Related U.S. Application Data
(60) Provisional application No. 63/533,205, filed on Aug. 17, 2023.

(51) Int. Cl. F16D 3/221

(52) U.S. Cl. CPC F16D 3/221; F16D 2250/0061; F16D 2250/0084

(57) ABSTRACT

A constant velocity joint includes an outer race, an inner race configured for pivotal movement relative to the outer race, and a shaft. The inner race is fixed to the shaft without a secondary component.

### CROSS-REFERENCE TO RELATED APPLICATION

This application claims the benefit of U.S. Provisional Application Ser. No. 63/533,205, filed Aug. 17, 2023, which is incorporated herein by reference in its entirety.

### FIELD OF THE INVENTION

The present disclosure generally relates to shaft assemblies for motor vehicles, and more specifically, to constant velocity joints for shaft assemblies.

### BACKGROUND OF THE INVENTION

Automotive shaft joint applications, such as constant-velocity joint (CVJ) assemblies, typically include a retaining ring for retention of an inner race of the constant velocity joint to a shaft (axle). Although the retaining ring is generally well-suited for its intended function, it requires a separate retaining ring component, and further requires fabrication of a ring groove in both the race and the shaft, such as in a machining process, which adds costly time and processes to the manufacture of the CVJ assembly. Further yet, tolerances for the ring groove and the thickness of the retaining ring need to be individually tight, and stack up tolerances therebetween can prove problematic in providing repeatable and accurate quality of assembly, and in addition, can allow for unwanted axial lash between the race and the shaft.

Accordingly, what is desired is a mechanism and process for assembly of a CVJ assembly that solves at least those issues identified above.

### SUMMARY OF THE INVENTION

An aspect of the present disclosure provides a constant velocity joint including an outer race, an inner race configured for pivotal movement relative to the outer race, and a shaft. The inner race is fixed to the shaft without a secondary component.

In accordance with a further aspect of the disclosure, the inner race is fixed to the shaft with mechanically upset material.

In accordance with another aspect of the disclosure, a method of assembling an inner race of a constant velocity joint to a shaft is provided. The method includes disposing the inner race on the shaft and fixing the inner race to the shaft without a secondary component.

In accordance with another aspect of the disclosure, the method further includes mechanically upsetting material of the inner race into locking engagement with the shaft.

These and other aspects, objects, advantages and features will become readily apparent to one possessing ordinary skill in the art in view of the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial perspective view of a constant velocity joint constructed in accordance with one aspect of the disclosure;

FIG. 2 is partial transparent view of the constant velocity joint of FIG. 1 showing an inner race fixed to a shaft of the constant velocity joint;

FIG. 3 is a cross-sectional view taken generally along the line 3-3 of FIG. 1 illustrating a mechanically upset connection of an inner race of the constant velocity joint to the shaft;

FIG. 4A is an end cross-sectional view taken generally along line 4A-4A of FIG. 3 looking along a central axis of the constant velocity joint illustrating mechanically upset region(s) of the inner race fixed to the shaft in accordance with one aspect of the disclosure; and

FIG. 4B is a view similar to FIG. 4A illustrating a circumferentially continuous mechanically upset region of an inner race fixed to the shaft in accordance with another aspect of the disclosure.

### DETAILED DESCRIPTION

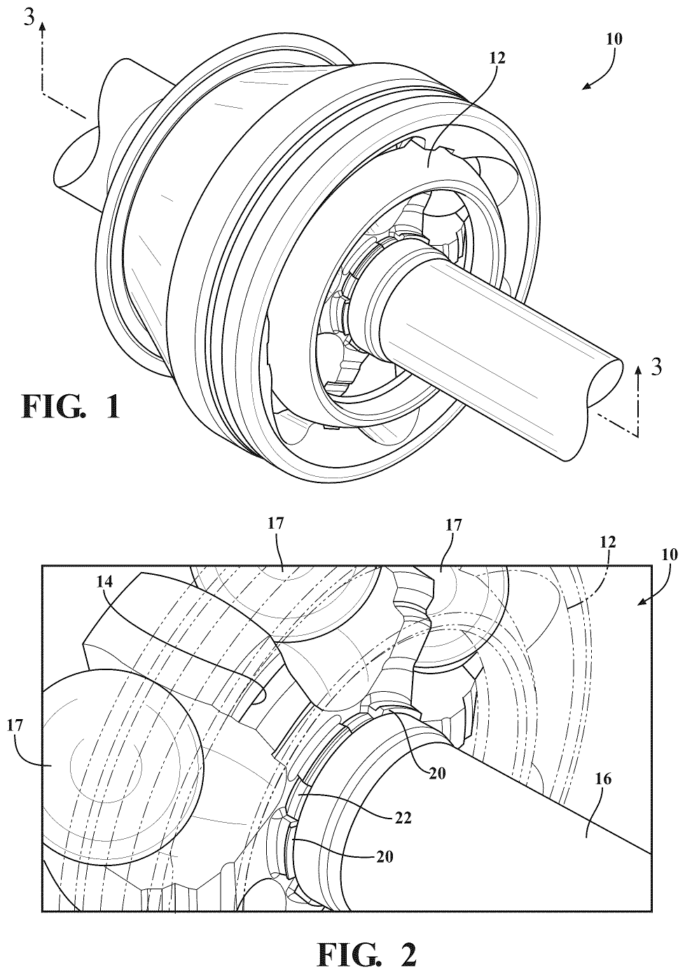

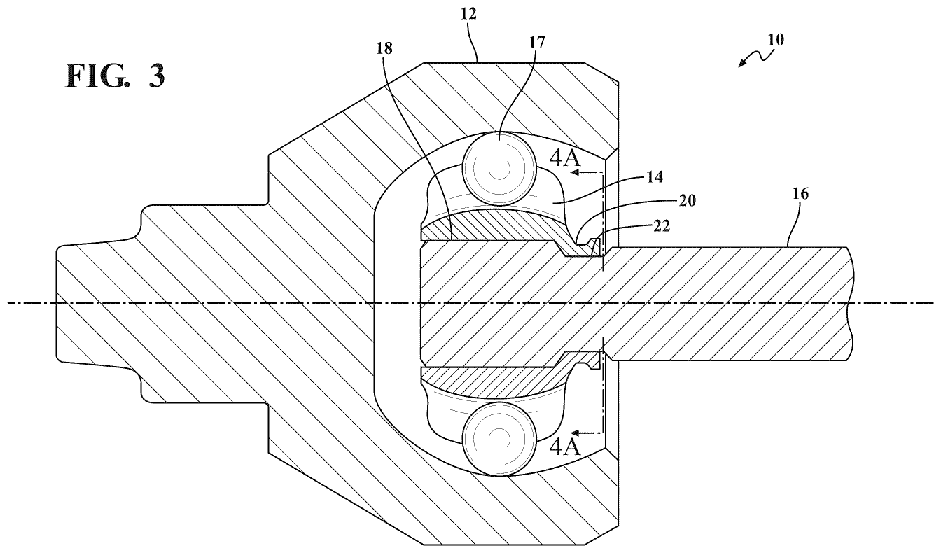

Referring now to the Figures, where the invention will be described with reference to specific embodiments, without limiting same, FIG. 1 illustrates constant velocity joint 10 including an outer race 12 an inner race 14 configured for pivotal movement relative to the outer race 12, and an axle, also referred to as shaft 16. The inner race 14 is fixed against movement to the shaft 16 without a secondary component, including without secondary mechanical components and secondary adhesive components. Accordingly, the inner race 14 is not fixed to the shaft 16 by a retainer ring, snap ring, or any other separate piece of material from the inner race 14 and the shaft 16. In the non-limiting embodiment illustrated, a plurality of roller members 17, shown as spherical balls, by way of example and without limitation, are disposed between the outer race 12 and the inner race 14 to allow for relative pivotal movement between the outer race 12 and the inner race 14. It is contemplated herein that the roller members 17 could allow for relative axial, plunging movement between the outer race 12 and the inner race 14, if desired.

The shaft 16 can be provided with a plurality of splines 18 to facilitate coupling the shaft 16 to the inner race 14 and to prevent relative rotation between the shaft 16 and the inner race 14. In accordance with a further aspect, the splines 18 are unhardened, and thus, no heat-treatment process is needed to provide full functionality to the splines 18. With the splines 18 remaining unhardened, the precision of the splines 18 is improved. The splines 18 can remain unhardened as a result of, and due to the rigidly fixed, secure connection between the inner race 14 and the shaft 16, discussed further below. Additionally, the splines 18 can be increased in relative length compared to splines of prior art shafts having a ring groove, thereby providing stronger splines in torsion, and thus, contributing to the splines 18 ability to remain unhardened.

The inner race 14 is fixed to the shaft 12 by mechanically upset material 20 of at least one of the inner race 14 and the shaft 12, and is shown in the non-limiting embodiment as being mechanically upset material of the inner race 14. In the non-limiting embodiment, the inner race 14 is constructed of case hardened carbon steel, and in one particular non-limiting embodiment, with 1050 case hardened carbon steel, with the case hardening being performed solely on the load bearing running surface of the inner race 14 against which roller members 17 move.

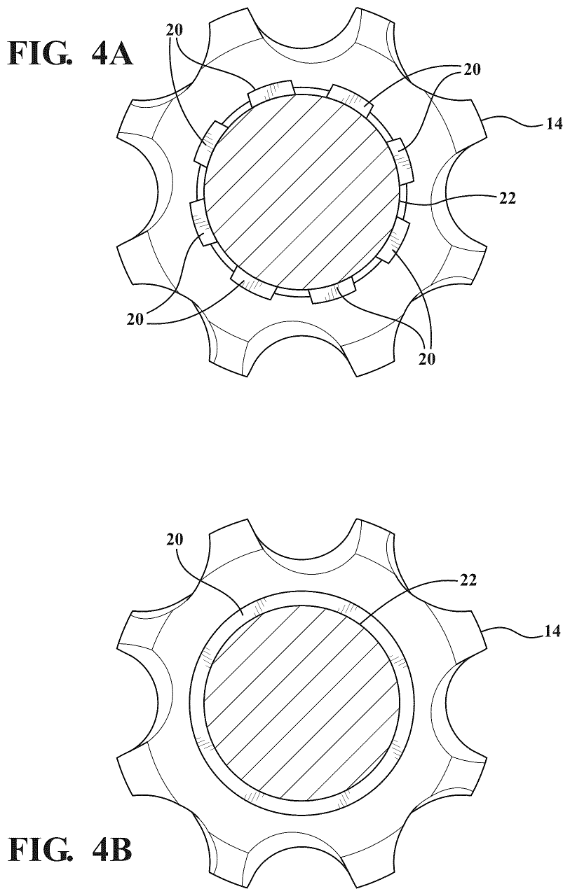

The mechanically upset material 20 of the inner race 14 can be upset via a swaging, staking, roll forming, or other mechanical material upsetting process, to form at least one, and shown in FIG. 4A as a plurality, radially inwardly extending tabs 20. Each tab 20 can be disposed in locked receipt in a corresponding recess or annular groove 22 formed in the shaft 16. With the tab(s) 20 being mechanically upset to extend into the corresponding recess or groove 22 and into engagement with the material of the shaft 16, the inner race 14 and the shaft 16 are effectively locked together, thereby preventing relative movement between the inner race 14 and the shaft 16, including preventing both relative axial and rotational movement therebetween. Accordingly, the inner race 14 and the shaft 16 are fixed for conjoint movement with one another, with no slop, also referred to as play, therebetween.

As discussed above, each tab 20 is mechanically upset and disposed in locked receipt in a corresponding recess or annular groove 22 formed in the shaft 16. As such, the inner race 14 can have one or more, also referred to as a plurality, tabs 20, wherein the plurality of tabs 20 can be equidistantly spaced from one another about the circumference of the inner race 14 (FIG. 4A). In the case of a plurality of tabs 20, the recess 22 in the shaft can be formed as a circumferentially continuous, annular groove 22, such that each of the tabs 20 is disposed without the single annular groove 22. Otherwise, a corresponding number of recesses 22 could be formed in the shaft 16, with the recesses being aligned for receipt of a corresponding one of the tabs 20 therein. Further yet, as illustrated in FIG. 4B, it is contemplated that a circumferentially continuous, annular tab 20 of material could be mechanically upset into the circumferentially continuous, annular groove 22.

In accordance with a further aspect of the disclosure, a method of assembling an inner race 14 of a constant velocity joint 10 to a shaft 16 of the constant velocity joint 10 is provided. The method includes disposing the inner race 14 on the shaft 16, and then fixing the inner race 14 to the shaft 16 without a secondary component, such as a retaining ring, snap ring, or any other secondary fastener formed of material separate from the inner race 14 and the shaft 16.

The method further includes mechanically upsetting material of at least one of the inner race 14 and the shaft 16 to fix the inner race 14 to the shaft 16. In the illustrated non-limiting embodiment, the method includes mechanically upsetting the material of the inner race 14, such as in one of a swaging process, a staking process, or a roll forming process.

The method can further include forming at least one recess or annular groove 22 in the outer surface of the shaft 16, and forming at least one tab 20 with the mechanically upset material of the inner race 14, with the at least one tab 20 disposed in locked receipt in the at least one recess or annular groove 22. The method can further include forming a plurality of recesses 22 in the shaft 16, and forming a plurality of tabs 20 with the mechanically upset material of the inner race 14, with each of the tabs 20 being disposed in a separate one of the recesses 22.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Individual elements or features of a particular embodiment are generally not limited to that particular embodiment, but, where applicable, are interchangeable and can be used in a selected embodiment, even if not specifically shown or described. Accordingly, the invention is not to be seen as limited by the foregoing description.

Having thus described the invention, it is claimed:

1. A constant velocity joint, comprising:
an outer race;
an inner race configured for pivotal movement relative to the outer race; and
a shaft,
wherein the inner race is fixed to the shaft without a secondary component.

2. The constant velocity joint of claim 1, wherein the inner race is fixed to the shaft without a retaining ring.

3. The constant velocity joint of claim 1, wherein the inner race is fixed to the shaft by mechanically upset material of at least one of the inner race and the shaft.

4. The constant velocity joint of claim 3, wherein the inner race is fixed to the shaft by mechanically upset material of the inner race.

5. The constant velocity joint of claim 4, wherein material of the inner race is swaged.

6. The constant velocity joint of claim 4, wherein material of the inner race is roll formed.

7. The constant velocity joint of claim 4, wherein material of the inner race is staked.

8. The constant velocity joint of claim 4, further including at least one recess in the shaft, wherein the mechanically upset material of the inner race forms at least one radially inwardly extending tab, the at least one tab disposed in locked receipt in the at least one recess.

9. The constant velocity joint of claim 8, wherein the at least one recess includes a plurality of recess and the at least one tab includes a plurality of tabs.

10. The constant velocity joint of claim 1, further including a plurality of rolling members disposed between the outer race and the inner race.

11. The constant velocity joint of claim 1, wherein the shaft has a plurality of unhardened splines.

12. A method of assembling an inner race of a constant velocity joint to a shaft, comprising:
disposing the inner race on the shaft; and
fixing the inner race to the shaft without a secondary component.

13. The method of claim 12, further including fixing the inner race to the shaft without a retaining ring.

14. The method of claim 13, further including mechanically upsetting material of at least one of the inner race and the shaft to fix the inner race to the shaft.

15. The method of claim 14, further including mechanically upsetting material of the inner race in a swaging process to fix the inner race to the shaft.

16. The method of claim 14, further including mechanically upsetting material of the inner race in a roll forming process to fix the inner race to the shaft.

17. The method of claim 14, further including mechanically upsetting material of the inner race in a staking process to fix the inner race to the shaft.

18. The method of claim 14, further including forming at least one recess in the shaft, and forming at least one tab with the mechanically upset material of the inner race, with the at least one tab disposed in locked receipt in the at least one recess.

19. The method of claim 18, further including forming a plurality of recesses in the shaft, and forming a plurality of tabs with the mechanically upset material of the inner race, with each of the tabs being disposed in a separate one of the recesses.

20. The method of claim 14, further including forming an annular recess in the shaft, and forming at least one tab with the mechanically upset material of the inner race, with the at least one tab disposed in locked receipt in the annular recess.
